(19) United States
(12) Patent Application Publication
(10) Pub. No.: US 2007/0254519 A1
(43) Pub. Date: Nov. 1, 2007

(54) Pressing mechanism for LED chip

(75) Inventors: Chung Wu, Taipei (TW); Meng-Cheng Huang, Taipei (TW); Zu-Chao Hsu, Taipei (TW)

Correspondence Address: HDSL, 4331 STEVENS BATTLE LANE, FAIRFAX, VA, 22033, US

(73) Assignee: Chaun-Choung Technology Corp.

(21) Appl. No.: 11/413,083

(22) Filed: Apr. 28, 2006

(51) Int. Cl. H01R 13/62

(52) U.S. Cl. 439/366

(57) ABSTRACT

A pressing mechanism presses the LED chip firmly to the base and includes a pressing device. The pressing device includes two parallel metal plates extended integrally from topside of the base and disposed on two sides of the LED chip. The metal plate includes a first pin connected to the base and a second pin extended parallel atop the base. The separation between the pressing plate and the base is slightly larger than the thickness of the LED chip. According to another preferred embodiment of the present invention, the pressing plate is a pressing clip. The pressing clip includes a connection end of substantially L shape and a floating end of substantially U shape. According to still another preferred embodiment of the present invention, the pressing mechanism includes two screws to fix the LED chip to the base on two radial sides of the LED chip.

### BACKGROUND OF THE INVENTION

1. Field of the Invention

The present invention relates to a LED lamp structure, especially to a connection structure for LED and the heat dissipation base thereof.

2. Description of Prior Art

The conventional tungsten lamps have drawbacks of high power consumption and fast battery consumption. Moreover, the wasted battery is also a threat to environment. Therefore, light emitting diodes (LEDs) with compact size and low power consumption are candidate for general lighting and other illumination applications such as traffic light, torch or advertisement. The LEDs are generally operated at room temperature due to its semiconductor characteristic. Therefore, heat dissipation is great issue for LEDs. In the conventional LED device, the LED is generally in contact with a base and the heat generated by the LED has heat exchange with outer environment through the base.

FIG. 1 shows a prior art LED and the circuit board thereof. The lamp stage 50P is disposed with a plurality of bases 30P. Each of the bases 30P is disposed with a LED chip 10P and tin paste is applied between the bases 30P and the LED chip 10P to increase contact area therebetween. Moreover, heat of the LED chip 10 can be dissipated through the base 30P. Two pins 11P are extended radially from the LED chip 10P such that the LED chip 10P can be powered through soldering the pins 11P with the wire 20P and applying electrical power through the wire 20P. Moreover, the LED chip 10P is also soldered to the base 30P.

The prior art LED 10P is fixed by soldering the wire 20P. As shown in FIG. 1, a plurality of LED chips 10P connected by the wire 20P will be subjected to tension when the LED chips 10P are moved or vibrated. This will result in:

1. The LED chip 10P is detached from the base 30P and the contact area is also reduced.

2. The illumination efficiency of the LED chip 10P is reduced because the contact area between the LED chip 10P and the heat generated by the LED chip 10P cannot completely conveyed to the base 30P.

### SUMMARY OF THE INVENTION

The present invention is to provide a pressing mechanism for LED chip and base thereof, wherein the LED chip can be firmly attached to the base to solve the problem encountered by prior art LED.

The present invention is to provide a contact structure with excellent heat dissipation for LED. Therefore, the heat generated by the LED chip can be rapidly conveyed to the base and the heat exchange can be speeded up. Moreover, a pressing mechanism is provided to firmly attach the LED chip to the base.

Accordingly, the present invention provides a pressing mechanism to press the LED chip firmly to the base. The base includes a round heat dissipation area at center thereof and being in contact with the LED chip, thus conducting heat of the LED chip outside. In one aspect of the present invention, the pressing mechanism is a metal pressing plate integrally extended from topside of the base. The pressing plate includes a first pin connected to the base and a second pin extended parallel atop the base. The separation between the pressing plate and the base is slightly larger than the thickness of the LED chip. Therefore, the LED chip can be firmly fixed to the base.

In another aspect of the present invention, the pressing plate is a pressing clip. The pressing clip includes a connection end of substantially L shape and a floating end of substantially U shape and floating atop the base to fix the LED chip. In still aspect of the present invention, the pressing mechanism includes two screws to fix the LED chip to the base on two radial sides of the LED chip.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a prior art LED structure.

FIG. 2 shows an exploded view of the first preferred embodiment of the present invention.

FIG. 3 shows a perspective of the first preferred embodiment of the present invention.

FIG. 4 shows a sectional view of FIG. 2.

FIG. 5 shows a sectional view of FIG. 3.

FIG. 6 shows still another preferred embodiment of the present invention.

FIG. 7 shows a perspective of the second preferred embodiment of the present invention.

FIG. 8 shows another implement for the embodiment in FIG. 8.

FIG. 9 shows a perspective of the third preferred embodiment of the present invention.

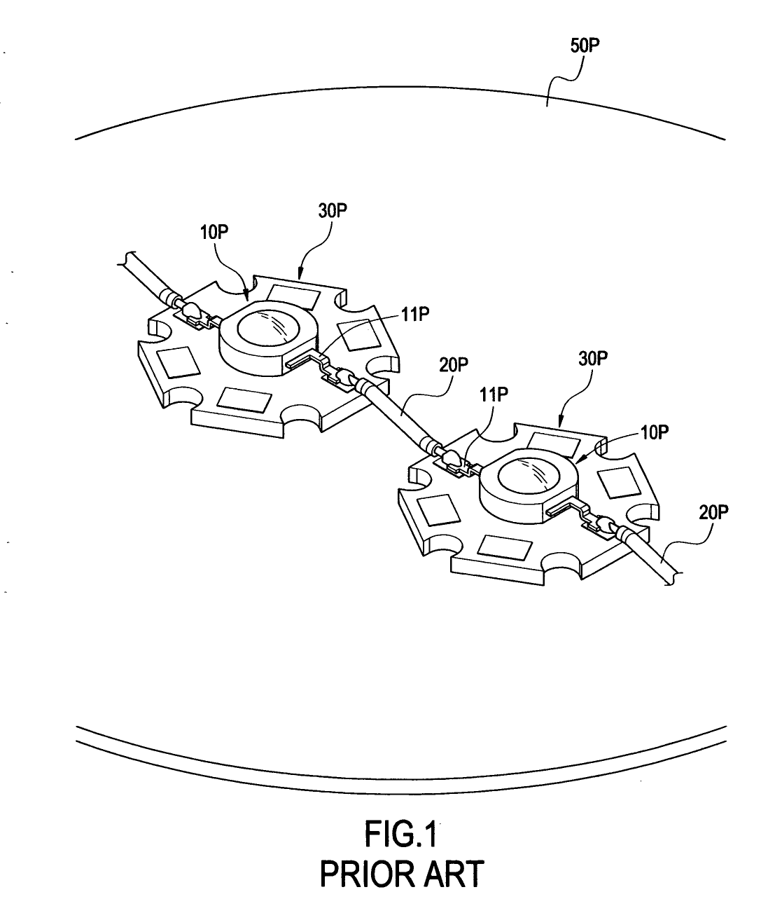

### DETAILED DESCRIPTION OF THE INVENTION

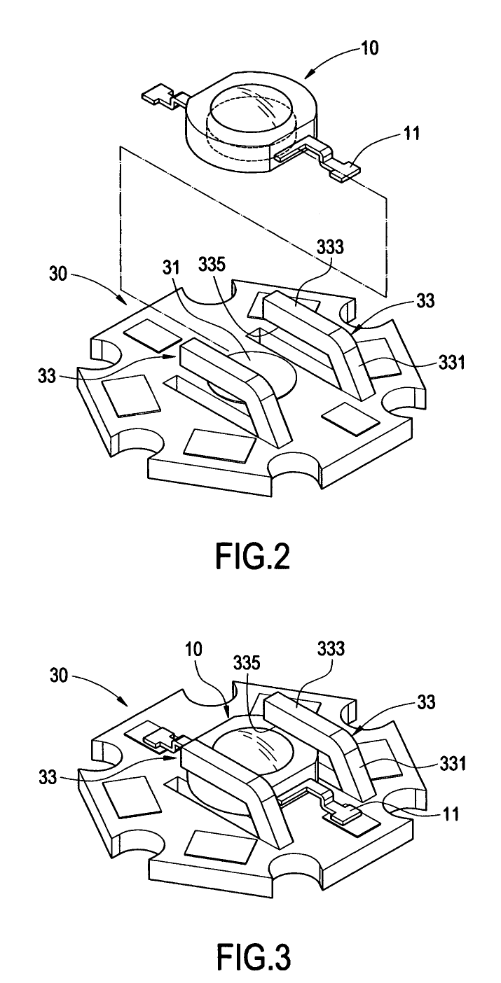

The present invention discloses a pressing mechanism to tightly attach the LED chip with a base for heat dissipation. With reference to FIGS. 2 and 3, a packaged LED chip 10 is pressed by a pressing device such as a pressing plate 33 to mount on a base 30. The LED chip is of round plate shape and includes two pins 11 extended radially therefrom and contacting an external power source. The base 30 includes a round heat dissipation area 31 corresponding to the LED chip 10 and in contact with the LED chip 10. A fin plate or other heat dissipation unit (not shown) is provided below the base 30 to increase heat exchange efficiency.

With also reference to FIGS. 2 and 3, two pressing plates 33 are parallel disposed on two sides of the LED chip 10. The pressing plates 33 are metal plates extended integrally from top side of the base 30. The pressing plate 33 includes a first pin 331 in contact with the base 30 and a second pin 333 extended atop the base 30 and parallel to the base 30. As shown in FIG. 3, the LED chip 33 can be pressed against the base 30 by the second pin 333.

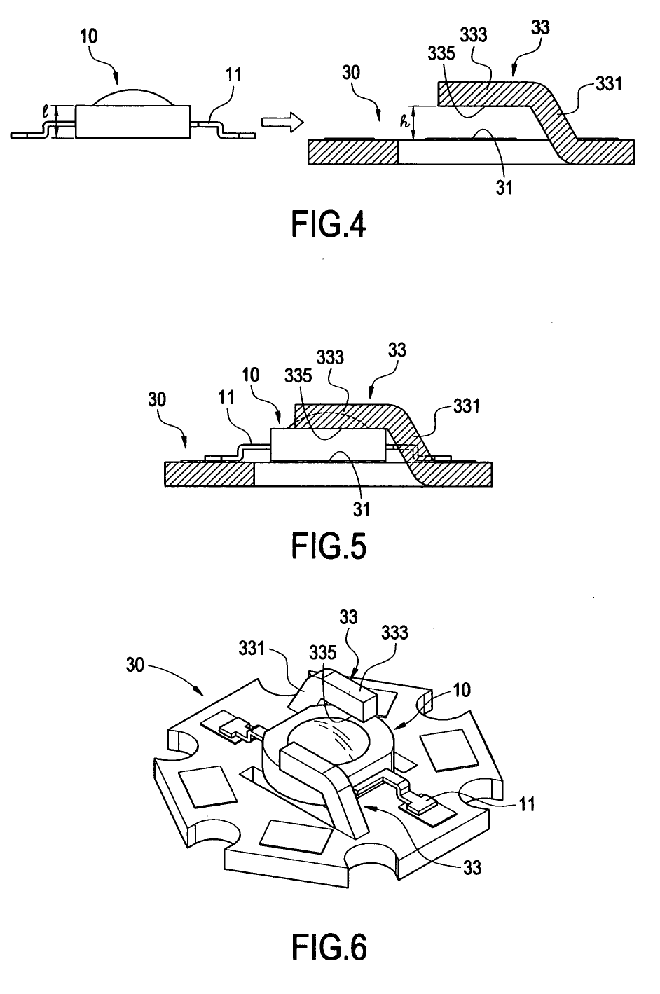

With reference to FIGS. 4 and 5, the second pin 333 is atop the base 30 and parallel to the base 30 with a separation h therebetween. Moreover, the LED chip 10 has a thickness 1 and h is slightly smaller than 1. Moreover, the pressing plates 33 are preferably made of metal with resilience. Therefore, the pressing plate 33 can be stretched outward to increase the separation between the second pin 333 and the base 30 such that the LED chip 10 can be placed between the pressing plate 33 and the base 30. In other word, the LED chip 10 can be inserted into a gap between the second pin 333 and the base 30. The resilient force of the pressing plate 33 is toward the base 30, therefore the LED chip 10 can be attached to the heat dissipation area 31 by the resilient force of the pressing plate 33.

FIG. 6 shows the perspective view of the pressing plate according to another preferred embodiment of the present invention. The first pins 331 of the pressing plate 33 are arranged on radial directions of the LED chip 10. The positions and shapes of the pressing plates 33 can be various as long as the pressing plates 33 can provide at least one pressing points and pressing areas. As shown in FIG. 3, the contact face 335 of the pressing plate 33 in contact with the LED chip 10 is the pressing area according to the preferred embodiment.

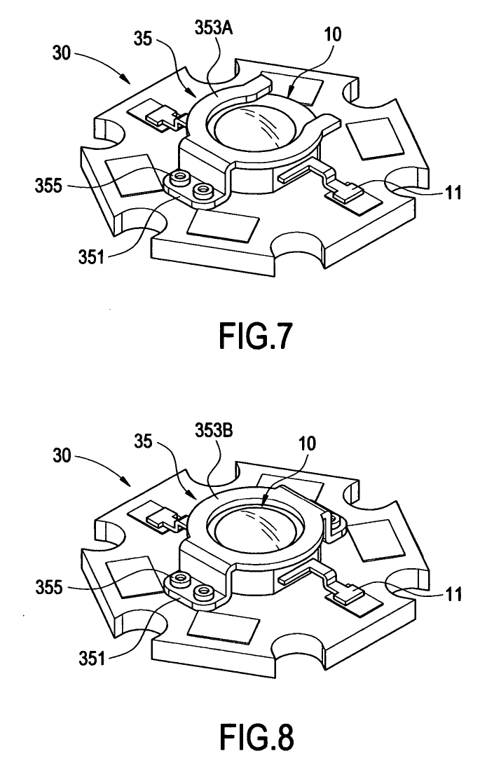

FIG. 7 shows the perspective view of the second preferred embodiment of the present invention. In the first preferred embodiment shown in FIG. 2, the pressing device is pressing plate 33 and integrally with the base 30. In the second preferred embodiment shown in FIG. 7, the pressing device is a pressing clip 35. The pressing clip 35 includes a connection end 351 of substantial L shape and a floating end 353A of substantial U shape. The pressing clip 35 is connected to the base 30 by fixing the connection end 351 to the base 30 with screw 355. The floating end 353A is placed atop the base 30 and floats atop the base 30. Similarly, the pressing clip 35 is made of resilient material such that the LED chip 10 can be pressed against the base 30 and has close contact with the heat dissipation area 31.

FIG. 8 shows another preferred embodiment of the present invention. The floating end 353B is an annulus ring and connected to the base 30 on two radial ends by using screws 355 to fix connection end 351 to the base 30. The floating ends 353A and 353B have surface contact with the LED chip 10. Therefore, the LED chip 10 can be effectively contacted to the base 30 to achieve desired heat dissipation effect.

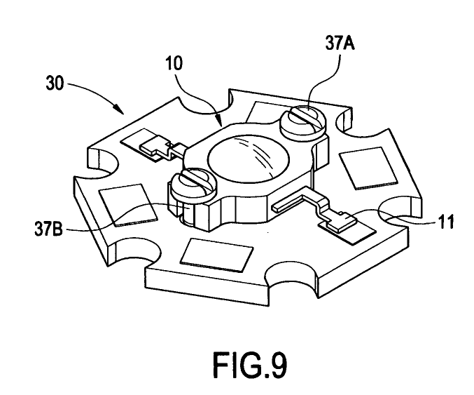

FIG. 9 shows still another preferred embodiment of the present invention, where two screws 37A are used to fix two radial sides of the LED chip 10. Moreover, the base 30 includes two threaded holes 37B corresponding to the screws 37A and the LED chip 10 is fixed to the base 30 by engaging the screws 37A with the threaded holes 37B. Therefore, the LED chip 10 can be in close contact with the base 30.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A pressing mechanism for tightly attaching an LED chip to a heat dissipation base, the pressing device comprising:
a base;
an LED chip mounted on the base; and
a pressing device arranged on the base and pressing the LED chip against the base.

2. The pressing mechanism as in claim 1, wherein the pressing device is a pressing plate.

3. The pressing mechanism as in claim 2, wherein the pressing plate is a plate extended upward from the base.

4. The pressing mechanism as in claim 3, wherein the pressing plate comprises a first pin connected to the base and a second pin extended parallel atop the base.

5. The pressing mechanism as in claim 4, wherein the second pin is substantially parallel to the base.

6. The pressing mechanism as in claim 5, wherein the distance between the pressing plate and the base is slightly smaller than the thickness of the LED chip.

7. The pressing mechanism as in claim 1, wherein the pressing device is a pressing clip.

8. The pressing mechanism as in claim 7, wherein the pressing clip comprises a connection end and a floating end, and the connection end is connected to the base.

9. The pressing mechanism as in claim 8, wherein the connection end is substantially of L shape.

10. The pressing mechanism as in claim 8, wherein the floating end is substantially of U shape.

11. The pressing mechanism as in claim 8, wherein the floating end is substantially of annulus shape.

12. The pressing mechanism as in claim 9, wherein the connection end is fixed to the base by screw.

13. The pressing mechanism as in claim 8, wherein the floating end is parallel extended atop the base.

14. The pressing mechanism as in claim 1, wherein the pressing device comprises two screws.

15. The pressing mechanism as in claim 14, wherein the base comprises two threaded holes.

16. The pressing mechanism as in claim 15, wherein the LED chip is fixed by screws at two ends thereof and the screws are engaged with the threaded holes.

17. The pressing mechanism as in claim 1, wherein the LED chip is of round plate shape and has two pins extended radially therefrom, and the two pins are connected to external power source.

18. The pressing mechanism as in claim 3, wherein the base comprises a round heat dissipation area in contact with the LED chip and carrying heat from the LED chip to external environment.
